(19) United States
(12) Patent Application Publication
(10) Pub. No.: US 2015/0232010 A1
(43) Pub. Date: Aug. 20, 2015

(54) SEATBELT GUIDE SUPPORT, SEAT BACK FRAME, AND SEAT DEVICE

(71) Applicant: TS TECH CO., LTD., ASAKA-SHI, SAITAMA (JP)

(72) Inventors: Takeshi Sato, Shioya-Gun (JP); Hideki Usami, Shioya-Gun (JP)

(21) Appl. No.: 14/415,766

(22) PCT Filed: Apr. 24, 2013
(86) PCT No.: PCT/JP2013/062019

§ 371 Date: Jan. 20, 2015

(30) Foreign Application Priority Data
Jul. 23, 2012 (JP) 2012-162976
Jul. 23, 2012 (JP) 2012-163026

(51) Int. Cl. B60N 2/68; B60N 2/64

(52) U.S. Cl. CPC B60N 2/688; B60N 2/686; B60N 2/682; B60N 2/64

(57) ABSTRACT

A seat device is provided with a seat back frame which has a seat frame section and which also has a seat belt guide support provided to the seat frame section. The seat belt guide support is provided with a mounting section to which a seat belt guide is mounted, leg sections which are provided to the mounting section and which can be affixed to the seat frame section, and an entry prevention section which is provided to the mounting section and which prevents a back pad from entering the gap between the mounting section and the seat frame section.

### TECHNICAL FIELD

The present invention relates to a seatbelt guide support tool that supports a seatbelt guide, and which is disposed on a seat frame section that supports a pad member. The present invention further relates to a seat back frame and a seat device.

### BACKGROUND ART

A seat (seat device) for an automobile is made up mainly from a seat cushion, and a seat back, a lower end portion of which is supported on the seat cushion. The seat back is constituted by attaching a cushion material and a skin material with respect to a seat back frame.

The seat back frame, for example, as disclosed in Japanese Laid-Open Patent Publication No. 2003-235672 and Japanese Laid-Open Patent Publication No. 2008-105593, includes a panel member (also referred to as a “panel frame”), and a frame body (also referred to as a “pipe frame”) arranged along the edges of the panel member. The frame body is attached to the panel member by way of welding or the like. If necessary, reinforcing frame members may be disposed on the frame body (see Japanese Laid-Open Patent Publication No. 2003-235672).

The seat is a so-called bench seat type, which is capable of seating three occupants simultaneously on a single horizontally elongate seat cushion. In the event that such a seat is used as a rear seat, for example as disclosed in Japanese Patent No. 4203907, a retractable armrest is provided in the center of the seat back, so that when a long object, such as skis or the like, is loaded into the automobile, the armrest is brought down forwardly to thereby enable a state of communication between the vehicle compartment and a trunk room.

In this case, a through hole is formed in the panel member that makes up the seat back frame. The vehicle compartment and the trunk room communicate mutually via the through hole. Stated otherwise, the through hole functions as a so-called trunk-through portion.

As can be understood from FIGS. 1 and 6 of Japanese Patent No. 4203907, the opening area of the through hole is comparatively large, and for this reason, the rigidity of the panel member around the periphery of the through hole is small. Thus, reinforcing frames (members) that extend along the through hole are disposed on the frame body, and as a result, the rigidity of the panel member around the through hole is ensured.

Further, in a vehicle such as an automobile or the like, a seat device, which is equipped with a so-called three-point type seatbelt, has been widely adopted. In this type of seat device, a technical concept is known in which a seatbelt guide is provided for guiding a seatbelt on an upper part (shoulder portion) of the seat back (for example, see Japanese Laid-Open Patent Publication No. 2012-056380).

A seat back of this type is equipped with a back frame section including a panel member and a frame body, a back pad, which is supported on the back frame section and is covered with a skin material, and a seatbelt guide support tool, which is fixed to the back frame section and serves to support the seatbelt guide.

### SUMMARY OF INVENTION

The seatbelt guide support tool, for example, includes a mounting section to which the seatbelt guide is attached, and leg sections disposed on the mounting section and which are capable of being fixed to the seat frame section.

In such a case, since a gap is formed between the mounting section and the back frame section (seat frame section), when the skin material is engaged (latched) onto the back frame section, a portion of the back pad becomes pressed (penetrates) into the gap. When this occurs, the back pad becomes deformed and damaged, and the feeling one experiences when seated on the seat device is deteriorated.

Further, if it is desired to enhance the rigidity of the aforementioned reinforcing frame, such an enhancement is handled by increasing the size or the wall thickness of the reinforcing frame. However, with such a countermeasure, a disadvantage is brought about in that the reinforcing frame is increased in size or made heavier in weight.

The present invention has been devised with the aforementioned problems in mind, and has the object of providing a seatbelt guide support tool, a seat back frame, and a seat device, which can suppress deformation and damage to the pad member, and accordingly, the feeling one experiences when seated can suitably be maintained.

Further, another object of the present invention is to provide a seat back frame in which an increase in size or weight around the periphery of the through hole of the panel member can be suppressed, while rigidity is ensured and the occurrence of deformation is suppressed.

[1] A seatbelt guide support tool according to the present invention supports a seatbelt guide, and is disposed on a seat frame section that supports a pad member that makes up part of a seat device. The seatbelt guide support tool comprises a mounting section to which the seatbelt guide is attached, a leg section disposed on the mounting section and which is capable of being fixed to the seat frame section, and an entry prevention section disposed on the mounting section, and which prevents the pad member from entering into a gap provided between the mounting section and the seat frame section.

With the seatbelt guide support tool according to the present invention, the entry prevention section is provided on the mounting section, which prevents the pad member from entering into the gap between the seat frame section and the mounting section. Consequently, when the skin material that covers the pad member is engaged on the seat frame section, a portion of the pad member can be prevented from entering into the gap. As a result, since deformation and damage to the pad member is suppressed, the feeling one experiences when seated on the seat device can suitably be maintained.

[2] In the above-described seatbelt guide support tool, the entry prevention section may be formed integrally with the mounting section.

In accordance with such a structure, since the entry prevention section is formed integrally with the mounting section, the rigidity of the entry prevention section can be increased.

[3] In the above-described seatbelt guide support tool, in a state in which the leg section is fixed to the seat frame section, the entry prevention section may extend from a rearward region positioned on a rearward side of the seat within the mounting section toward a side at which the leg section is positioned.

In accordance with such a structure, in a state in which the leg section is fixed to the seat frame section, the entry prevention section is formed to extend from a rearward region positioned on a rearward side of the seat within the mounting section toward a side where the leg section is positioned. Consequently, within the pad member, a pad rear portion, which is positioned rearwardly of the seatbelt guide support tool, can suitably be suppressed from penetrating into the gap.

[4] In the above-described seatbelt guide support tool, the entry prevention section may extend from a rear end of the mounting section.

In accordance with such a structure, since the entry prevention section extends out from the rear end of the mounting section, the pad rear portion can more effectively be suppressed from penetrating into the gap.

[5] In the above-described seatbelt guide support tool, in a state in which the leg section is fixed to the seat frame section, the rearward region may include a first region that extends in a widthwise direction of the seat, and a second region that extends in a forwardly slanted direction from the first region, such that the entry prevention section extends from the first region.

In accordance with such a structure, in a state in which the leg section is fixed to the seat frame section, the rearward region of the mounting section includes the first region that extends in a widthwise direction of the seat, and the second region that extends in a forwardly inclined direction from the first region. Therefore, the thickness of the region (thin-walled region), which is positioned rearwardly of the first region within the pad rear portion, is thinner than the thickness of the region (thick-walled region), which is positioned rearwardly of the second region. In addition, although the thin-walled region of the pad member enters more easily into the gap than the thick-walled region, because the entry prevention section is provided on the first region, penetration of the thin-walled region into the gap can be suppressed more suitably.

[6] In the above-described seatbelt guide support tool, a distal end part of the entry prevention section may be bent toward an inner side of the mounting section.

In accordance with such a structure, since the distal end part of the entry prevention section is bent toward an inner side of the mounting section, damage to the pad member by the entry prevention section can suitably be suppressed.

[7] In the above-described seatbelt guide support tool, a hole for attachment of the seatbelt guide is formed in the mounting section, and the entry prevention section may be disposed adjacent to the hole in the mounting section.

In accordance with such a structure, even in the case that the hole for attachment of the seatbelt guide is formed on the mounting section, since the entry prevention section is disposed adjacent to the hole in the mounting section, a decrease in the rigidity of the mounting section can be suppressed. Consequently, the seatbelt guide can be attached stably to the mounting section.

[8] In the above-described seatbelt guide support tool, in a state in which the leg section is fixed to the seat frame section, the entry prevention section may be formed to remain out of contact with the seat frame section.

In accordance with such a structure, since the entry prevention section remains out of contact with the seat frame section, abnormal noises produced by contact (i.e., hitting against one another) between the entry prevention section and the seat frame section can suitably be suppressed.

[9] In the above-described seatbelt guide support tool, in a state in which the leg section is fixed to the seat frame section, the entry prevention section may be formed to extend rearwardly of the seat frame section in overlapping relation to the seat frame section when viewed from front.

In accordance with such a structure, since in a state in which the leg section is fixed to the seat frame section, the entry prevention section extends rearwardly of the seat frame section in overlapping relation to the seat frame section when viewed from the front, the pad rear portion can more effectively be suppressed from penetrating into the gap.

[10] A seat back frame according to the present invention is equipped with a seat frame section having a panel member and a frame body joined to the panel member and which supports a pad member that makes up part of a seat device, and a seatbelt guide support tool that supports a seatbelt guide and is disposed on the seat frame section. The seatbelt guide support tool comprises a mounting section to which the seatbelt guide is attached, a leg section disposed on the mounting section and which is capable of being fixed to the seat frame section, and an entry prevention section disposed on the mounting section, and which prevents the pad member from entering into a gap provided between the mounting section and the seat frame section, wherein a through hole is formed in the panel member. The frame body comprises an edge frame disposed around an edge of the panel member, and a bridge frame that is bridged over the edge frame and is disposed around the through hole, wherein at least a portion of the bridge frame is covered by a reinforcing member.

With the seat back frame according to the present invention, the entry prevention section is provided on the mounting section, which prevents the pad member from entering into the gap between the seat frame section and the mounting section. Consequently, when the skin material that covers the pad member is engaged on the seat frame section, a portion of the pad member can be prevented from entering into the gap. As a result, since deformation and damage to the pad member is suppressed, the feeling one experiences when seated on the seat device can suitably be maintained.

Further, the bridge frame is disposed around the through hole of the panel member, and the bridge frame is covered by the reinforcing member. Accordingly, an increase in size or weight is suppressed, while rigidity of the seat back frame in which the through hole is formed can be ensured, while in addition, the occurrence of deformation of the seat back frame can be suppressed.

[11] In the above-described seat back frame, the through hole may extend from a lower part on a seat surface side to an upper part on a side at which a headrest is attached, and the reinforcing member may be arranged at least at an intermediate portion in a heightwise direction of the bridge frame.

In accordance with such a structure, since the reinforcing member is arranged at least at an intermediate portion in a heightwise direction of the bridge frame, an increase in the size or weight of the reinforcing member can be avoided.

[12] In the above-described seat back frame, an engaging member for engagement with a trim cord may be disposed around the through hole, the reinforcing member may extend in parallel with respect to the engaging member, and at least a portion of the reinforcing member and a portion of the engaging member may face one another mutually in parallel.

In accordance with such a structure, since at least a portion of the reinforcing member and a portion of the engaging member for engagement with the trim cord face one another mutually in parallel, the rigidity of the engaging member can be ensured.

[13] In the above-described seat back frame, a plurality of engaging members for engagement with trim cords may be disposed around the through hole, the reinforcing member may extend in parallel with respect to the plurality of engaging members, and at least a portion of the reinforcing member and portions of the plurality of engaging members may face one another mutually in parallel.

In accordance with such a structure, since at least a portion of the reinforcing member and portions of the plurality of engaging members for engagement with the trim cords face one another mutually in parallel, the rigidity of each of the engaging members can be ensured.

[14] In the above-described seat back frame, a window may be formed in the reinforcing member, and the reinforcing member and a region of the bridge frame that is exposed from the window may be joined to each other by welding.

In accordance with such a structure, the window is formed in the reinforcing member, and the reinforcing member and a region of the bridge frame that is exposed from the window are joined to each other by welding. Consequently, the bonding strength between the reinforcing member and the bridge frame is increased, and as a result, the rigidity of the bridge frame is further enhanced. Naturally, the mounting rigidity of the reinforcing member and the bridge frame also is improved.

[15] In the above-described seat back frame, the frame body may include, as the bridge frame, two members arranged on opposite ends of the through hole, the reinforcing members may be disposed respectively on each of the two bridge frames, the windows may be formed respectively on opposite ends of the reinforcing members, and the reinforcing members and the regions of the bridge frames that are exposed from the windows may be joined to each other by welding.

In accordance with such a structure, since the reinforcing members are disposed respectively on two bridge frames that are arranged on opposite ends of the through hole, enhanced rigidity is ensured. Further, since the windows are formed respectively on opposite ends of the reinforcing members, and the reinforcing members and the regions of the bridge frames that are exposed from the windows are joined to each other by welding, the rigidity of the bridge frames is further enhanced, and the mounting rigidity of the reinforcing members to the bridge frames also is improved.

[16] In the above-described seat back frame, the bridge frame may be circular in cross section, with an end of the reinforcing member being arcuately shaped in cross section and welded to the bridge frame, and a region other than the end of the reinforcing member being gate-shaped in cross section.

In accordance with such a structure, while the bridge frame is circular in cross section, the end of the reinforcing member is arcuately shaped in cross section, whereas a region other than the end of the reinforcing member is gate-shaped in cross section. Accordingly, the reinforcing member can be manufactured easily, and the end thereof can easily be welded to the bridge frame.

[17] In the above-described seat back frame, a bead may be disposed on the panel member, and the bead may extend to a lower side of a vehicle body mounting portion provided on a lower end of the panel member.

In accordance with such a structure, since the bead is provided on the panel member, and the bead extends to a lower side of a vehicle body mounting portion that is provided on the lower end of the panel member, the location at which rigidity is enhanced is increased, and thus the rigidity of the seat back frame is further enhanced.

[18] In the above-described seat back frame, the seat back frame is for a rear seat, and the through hole may serve to provide a state of communication between a vehicle compartment and a trunk room.

In accordance with such a structure, the rigidity around the trunk-through portion of the rear seat can be ensured.

[19] A seat device according to the present invention may comprise a pad member, a seat frame section that supports the pad member, a skin material covering the pad member, and a seatbelt guide support tool that supports a seatbelt guide and is disposed on the seat frame section. The seatbelt guide support tool comprises a mounting section to which the seatbelt guide is attached, a leg section disposed on the mounting section and which is capable of being fixed to the seat frame section, and an entry prevention section disposed on the mounting section, and which prevents the pad member from entering into a gap provided between the mounting section and the seat frame section. In this case, a seat device can be obtained that offers the same advantages as those of the aforementioned seatbelt guide support tool.

### BRIEF DESCRIPTION OF DRAWINGS

FIG. 1 is a schematic perspective view of a seat device equipped with a seatbelt guide support tool according to an embodiment of the present invention;

FIG. 2 is an exploded perspective view of a seat back constituting part of the seat device shown in FIG. 1;

FIG. 3 is a schematic overall front view of a seat back frame that makes up the seat back;

FIG. 4 is a cross sectional view taken along line IV-IV of FIG. 3;

FIG. 5 is a cross sectional view taken along line V-V of FIG. 3;

FIG. 6 is a schematic view with partial omission as seen from a seat-front side of the seat back frame;

FIG. 7 is a plan view of the seatbelt guide support tool;

FIG. 8 is a schematic view with partial omission as seen from a seat-rear side of the seat back frame;

FIG. 9 is a cross sectional view with partial omission showing the seatbelt guide support tool, which constitutes part of the seat device, and a surrounding vicinity thereof;

FIG. 10 is a cross sectional view taken along line X-X of FIG. 9; and

FIG. 11 is a cross sectional view with partial omission of a seat device equipped with a seatbelt guide support tool according to a modification.

### DESCRIPTION OF EMBODIMENTS

Preferred embodiments of a seatbelt guide support tool, a seat back frame, and a seat device according to the present invention will be described in detail below with reference to the accompanying drawings. In each of the drawings, as viewed in a direction of a seated occupant of the vehicle, the arrow “L” indicates a left side of the seat device, the arrow “R” indicates a right side of the seat device, the arrow “Fr” indicates a frontward direction of the seat device, and the arrow “Rr” indicates a rearward direction of the seat device.

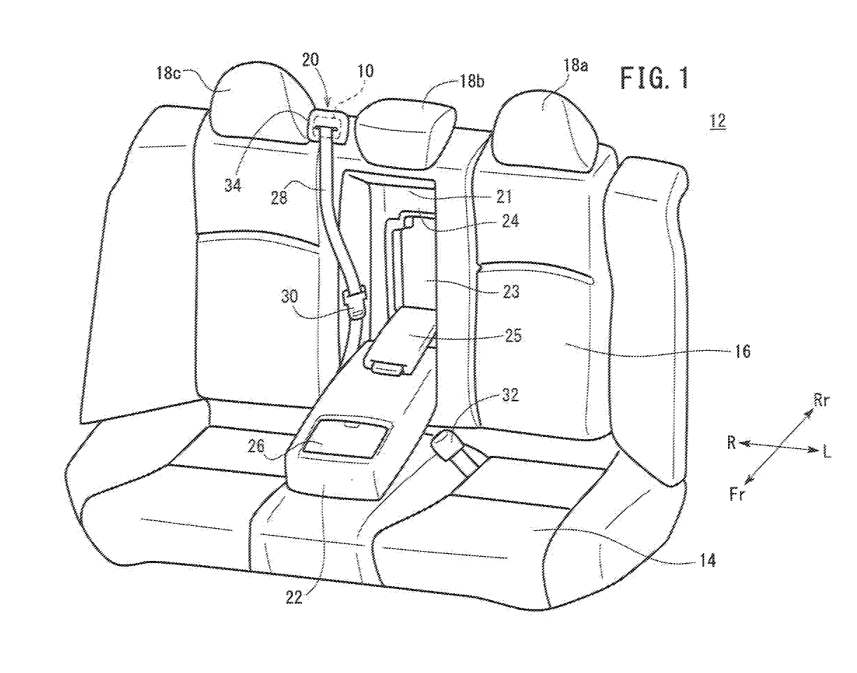

A seat device 12 according to an embodiment of the present invention is used as a rear seat that allows three people to be seated in an automobile. As shown in FIG. 1, the seat device 12 is equipped with a seat cushion 14 that supports the buttocks and thighs of respective vehicle occupants, a seat back 16 that supports the backs of the occupants, three headrests 18a to 18c that support the heads of the occupants, and a seatbelt device 20. The seat cushion 14 is mounted on a non-illustrated vehicle body, and the headrests 18a to 18c are disposed so as to be capable of being vertically adjusted on an upper end of the seat back 16.

The seat back 16 is supported tiltably on a rear end of the seat cushion 14, and includes an armrest 22, which is capable of being accommodated in a rectangular hole 21, which is formed substantially in a center portion in the widthwise direction (seat width direction, lateral direction). Further, the seat back 16 includes a lid frame 24, which is arranged in covering relation to a back side of the hole 21, and in which an opening (trunk-through portion) 23 is included that enables communication between a vehicle compartment and a trunk room. In the lid frame 24, an openable/closable lid 25 is mounted, which is capable of closing the opening 23.

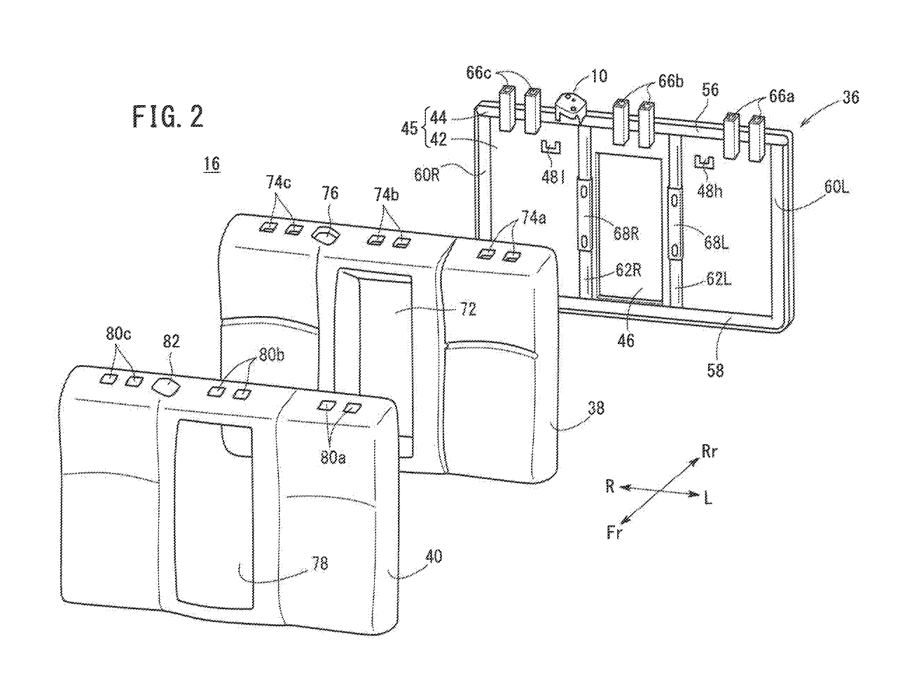

The armrest 22 is disposed rotatably with respect to a later-described seat back frame 36 (see FIG. 2), and includes a cup holder 26. Illustration of the armrest 22 is omitted from FIG. 2.

The seatbelt device 20 includes a seatbelt (a so-called three-point type seatbelt) 28 for restraining an occupant who is seated in the middle. The seatbelt device 20 further includes a tongue plate 30 disposed on the seatbelt 28, a buckle 32, which is fixed to the seat cushion 14 and enables attachment of the tongue plate 30, and a seatbelt guide 34 for guiding the seatbelt 28. As can be understood from FIG. 1, the seatbelt guide 34 is mounted at a location between the headrest 18b and the headrest 18c on an upper part (shoulder portion) of the seat back 16.

As shown in FIG. 2, the seat back 16 includes the seat back frame 36 (also referred to as a “back frame 36”), a back pad (pad member) 38 that covers the back frame 36, and a skin material 40 that covers the back pad 38. The back frame 36 constitutes a skeleton of the seat back 16, and is connected while capable of being tilted forward and backward on a rear end portion of a non-illustrated lower frame as a skeleton of the seat cushion 14.

The back frame 36 includes a panel member 42, a seat frame section 45 having a frame body (main frame) 44 fixed to the panel member 42, and a seatbelt guide support tool 10 (also referred to as a “support tool 10”), which is disposed on the frame body 44.

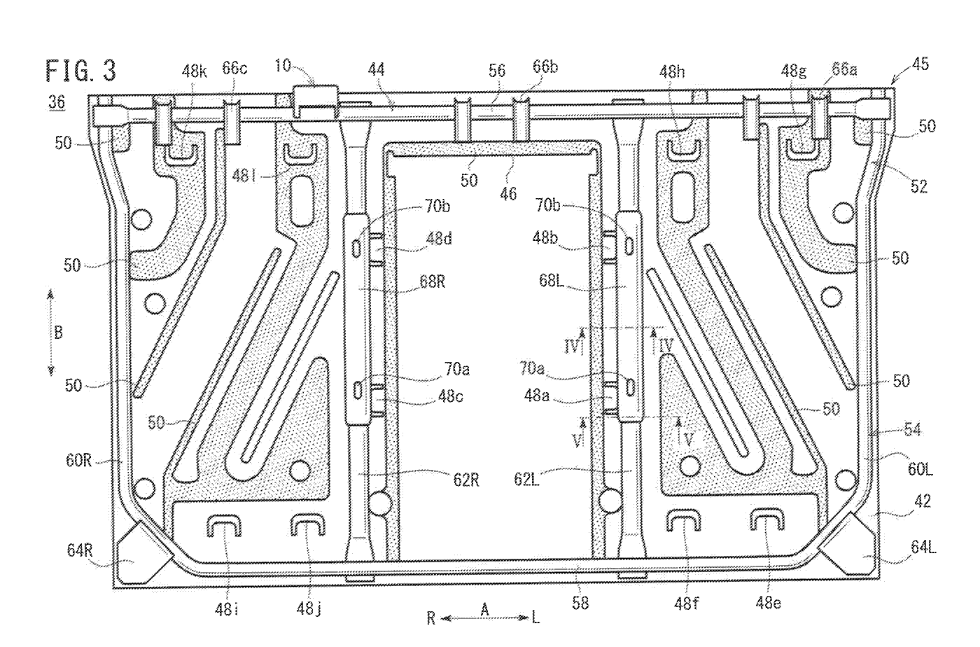

As shown in FIG. 3, the panel member 42 is made up from a substantially rectangular flat plate with a small wall thickness, which generally is constituted by an aluminum alloy, a resin material, or the like. A through hole (opening) 46 is formed substantially centrally in the widthwise direction (the directions of the arrow A in FIG. 3) of the panel member 42. The through hole 46 has a vertically elongate rectangular shape.

Around the periphery of the through hole 46, a plurality of engaging members 48a to 48d are disposed for engagement with later-described trim cords 84 provided on the skin material 40. In this case, the engaging members 48a to 48d are disposed as slightly elongated gate-shaped members substantially parallel to the vertical direction of the through hole 46. Reference numerals 48e to 48l also indicate engaging members for engagement with the trim cords 84.

Further, as shown by the dots in FIG. 3, beads 50 for enhancing the rigidity of the panel member 42 are provided on an end surface on the vehicle compartment side of the panel member 42. The beads 50 are provided as groove shaped stepped portions, which are recessed from the top surface of the vehicle compartment side end surface. Moreover, the beads 50 are mirror-symmetrical to a central line of symmetry in the widthwise direction (the directions of the arrow A in FIG. 3) of the through hole 46. Further, each one of the pair of engaging members 48a, 48c, the pair of engaging members 48b, 48d, the pair of engaging members 48e, 48i, the pair of engaging members 48f, 48j, the pair of engaging members 48g, 48k, and the pair of engaging members 48h, 48l are disposed in mirror symmetrical positions.

As can be understood from FIG. 3, the beads 50 are formed at positions surrounding the through hole 46. Therefore, the rigidity around the through hole 46 is ensured.

The frame body 44 includes an edge frame 52, which is arranged on the edge of the panel member 42. The edge frame 52 is made up from a U-shaped frame member 54 and an upper frame member 56.

The U-shaped frame member 54 includes a lower frame part 58, which extends along the lower edge of the panel member 42, and side frame parts 60L, 60R, which extend along the edges on both sides of the panel member 42. On the other hand, the upper frame member 56 bridges between upper end portions of both side frame parts 60L, 60R. More specifically, the lower part and both side parts of the edge frame 52 are made up from the U-shaped frame member 54, whereas the upper part is made up from the upper frame member 56 itself.

Opposite ends of the upper frame member 56 are formed as hook portions. The hook portions are latched over and welded to upper end portions of the side frame parts 60L, 60R of the U-shaped frame member 54.

The frame body 44 includes two bridge frame members 62L, 62R (bridge frames), which span from the lower frame part 58 of the U-shaped frame member 54, i.e., the lower part of the edge frame 52, to the upper frame member 56, i.e., the upper part of the edge frame 52. The bridge frame members 62L, 62R extend in a vertical direction of the through hole 46 (in the directions of the arrow B of FIG. 3) on the periphery of the through hole 46. Stated otherwise, the longitudinal direction of the bridge frame members 62L, 62R is substantially parallel to the vertical direction of the through hole 46. Accordingly, the longitudinal direction of the bridge frame members 62L, 62R, the longitudinal direction of the engaging members 48a to 48d, and the vertical direction of the through hole 46 are in a relationship of being substantially parallel to one another mutually.

Opposite ends of the bridge frame members 62L, 62R are formed as hook portions, in the same manner as the opposite ends of the upper frame member 56. The hook portions are latched over and welded to upper and lower parts of the edge frame 52. Vertically elongate recesses (not shown) are formed in the vicinity of the lower edge and the upper edge of the panel member 42. Respective ends of the bridge frame members 62L, 62R, i.e., the hook portions, are inserted into the respective vertically elongate recesses.

The U-shaped frame member 54, the upper frame member 56, and the bridge frame members 62L, 62R referred to above are constituted by hollow circular pipe bodies made, for example, from a metal material such as steel, aluminum alloy, or the like. In this case, bent portions between the side frame parts 60L, 60R and the lower frame part 58 on the U-shaped frame member 54 are welded to support members 64L, 64R (vehicle body mounting portions), which are connected to the panel member 42. Further, the upper end back surfaces of the side frame parts 60L, 60R are welded to the panel member 42. Furthermore, stay supports 66a to 66c for supporting the headrests 18a to 18c (see FIG. 1) are disposed on the upper frame member 56 by welding.

In addition, as understood from FIG. 3, portions of the beads 50 extend from below the bent portions of the U-shaped frame member 54 to below the upper frame member 56. More specifically the beads 50 are positioned at plural locations downwardly of the frame body 44.

Intermediate portions in the heightwise direction (the directions of the arrow B in FIG. 3) of the bridge frame members 62L, 62R are covered, respectively, by elongated reinforcing members 68L 68R. More specifically, in the present embodiment, the bridge frame members 62L, 62R are reinforced by the reinforcing members 68L, 68R.

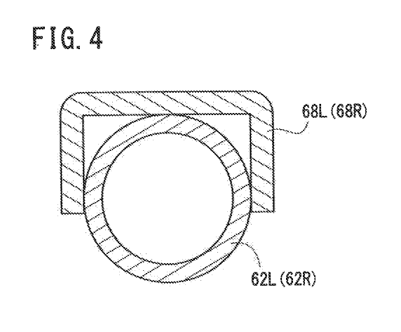

As shown in FIG. 4, the cross sections of intermediate portions of the reinforcing members 68L, 68R are of a gate-like shape (C-shaped in cross section), the openings of which are oriented downwardly. Accordingly, inner walls (both side walls and the ceiling wall) of the reinforcing members 68L, 68R are in point contact or line contact with respect to the outer walls of the bridge frame members 62L, 62R.

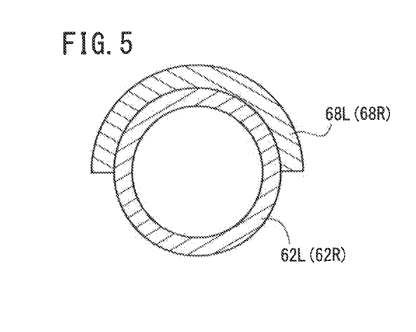

On the other hand, as shown in FIG. 5, the cross sections at the ends of the reinforcing members 68L, 68R are arcuately shaped in substantially semicircular shapes. The curvature thereof is substantially the same as the curvature of the bridge frame members 62L, 62R, which are circular in cross section. Accordingly, the inner walls at ends of the reinforcing members 68L, 68R abut against the outer walls of the bridge frame members 62L, 62R.

In the vicinity of opposite ends of the reinforcing members 68L, 68R, windows 70a, 70b are formed to penetrate therethrough, respectively. As a result, outer walls of the bridge frame members 62L, 62R are exposed from the windows 70a, 70b.

Regions in the vicinity of the windows 70a, 70b and the ends of the reinforcing members 68L, 68R are joined to the bridge frame members 62L, 62R by welding. Furthermore, the reinforcing members 68L, 68R are joined at suitable positions to the bridge frame members 62L, 62R by spot welding. By being joined in this manner, falling off of the reinforcing members 68L, 68R from the bridge frame members 62L, 62R is prevented.

As shown in FIG. 3, the lower end of the reinforcing member 68L is positioned below the lower end of the engaging member 48a, and the upper end thereof is positioned above the upper end of the engaging member 48b. In a similar manner, concerning the reinforcing member 68R, the lower end thereof is positioned below the lower end of the engaging member 48c, and the upper end is positioned above the upper end of the engaging member 48d. More specifically, in the present embodiment, the engaging members 48a, 48b are disposed in parallel and in facing relation to the reinforcing member 68L across the entirety thereof. Similarly, the engaging members 48c, 48d are disposed in parallel and in facing relation to the reinforcing member 68R across the entirety thereof.

The back pad 38 is constituted, for example, by a flexible foam material such as polyurethane foam, polypropylene foam, polyethylene foam, etc. The back pad 38 has a shape that corresponds with the shape of the back frame 36, and is capable of covering the outer surface of the back frame 36.

Further, an opening 72 is formed substantially in the center in the widthwise direction of the back pad 38, and on the upper surface of the back pad 38, plural insertion holes 74a to 74c are formed through which the respective stay supports 66a to 66c can be inserted, together with a placement hole 76 in which the support tool 10 can be placed.

The skin material 40 is constituted from a flexible material such as PVC (polyvinyl chloride) leather, true leather, or a film, etc., which is capable of covering the outer surface of the back pad 38.

Further, within the skin material 40, at a location covering the front surface of the back pad 38, an opening 78 is formed substantially in the center in the widthwise direction. At a location covering the upper surface of the back pad 38 within the skin material 40, plural insertion holes 80a to 80c are formed through which the respective stay supports 66a to 66c can be inserted, together with a placement hole 82 in which the support tool 10 can be placed.

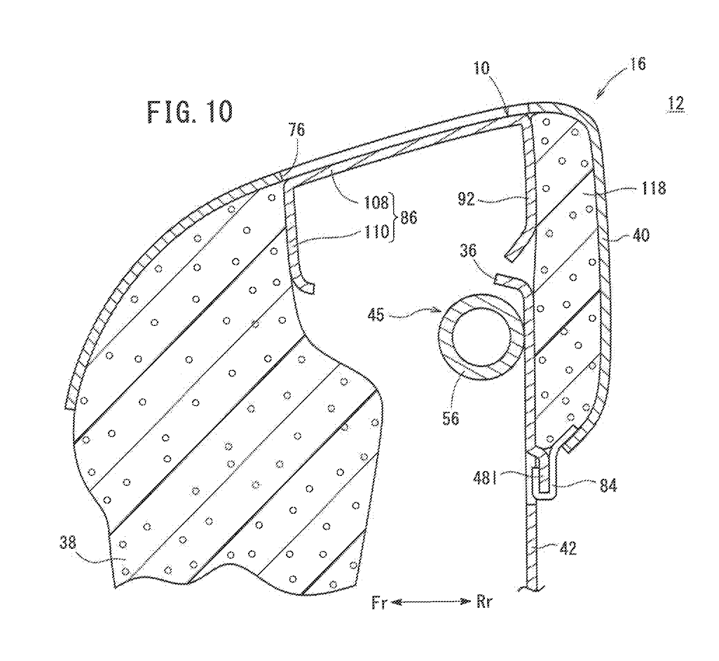

On an end of the skin material 40, trim cords (engagement devices) 84 are secured to the skin material 40, for engagement with the engaging members 48a to 48l that are formed on the panel member 42 (see FIG. 10). As a result, since the skin material 40 can easily be fixed to the back frame 36 under a condition in which tension is applied to the skin material 40, wrinkles or the like are unlikely to occur in the visible surface of the skin material 40.

With the seat back 16 constructed in this manner, the above-described hole 21 is constituted by the through hole 46 of the back frame 36, the opening 72 of the back pad 38, and the opening 78 of the skin material 40.

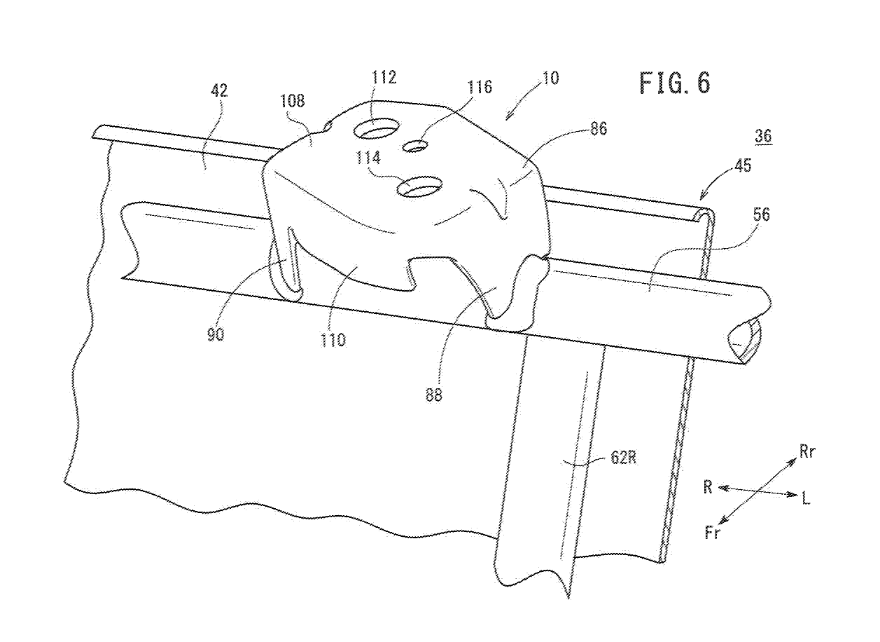

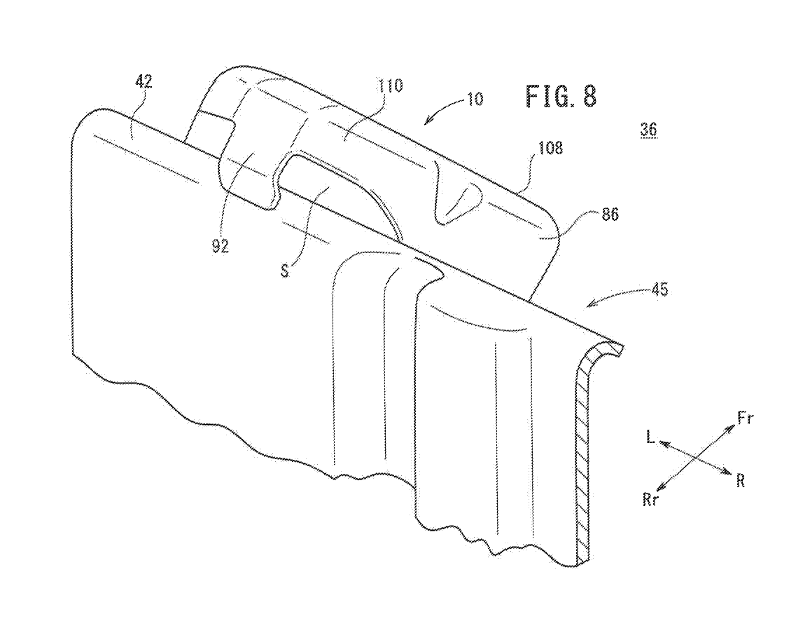

Next, a description will be given concerning the support tool 10 that makes up the back frame 36. As shown in FIGS. 6 through 8, the support tool 10 is made, for example, from a metal material such as an iron-based material or the like, and includes a mounting section 86 to which the seatbelt guide 34 is attached, and leg sections 88, 90 (fixing members) disposed in a pair on the mounting section 86, and which are capable of being fixed to the upper frame member 56. The support tool 10 further comprises an entry prevention section 92, which is disposed on the mounting section 86, and which prevents a portion of the back pad 38 from entering into a gap S (see FIG. 8) between the back frame 36 (panel member 42) and the mounting section 86.

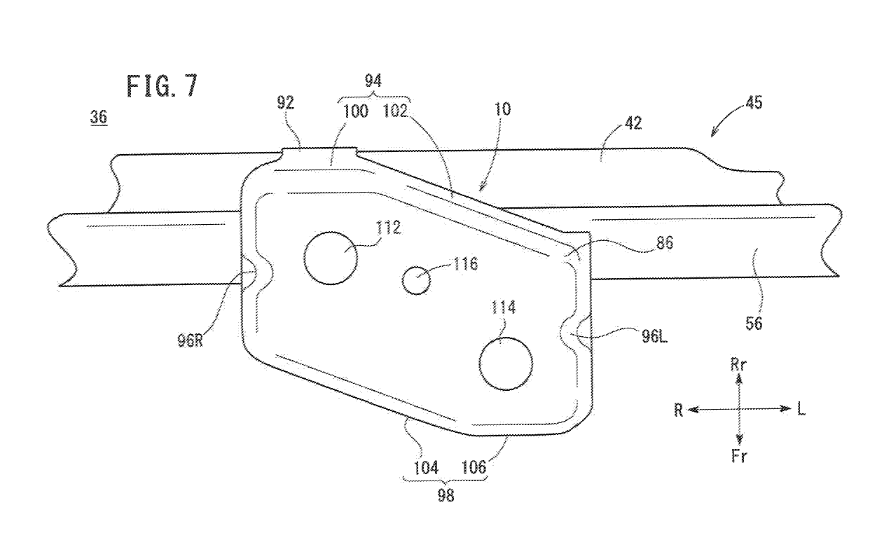

The mounting section 86 is of a shape that corresponds to the shape of the seatbelt guide 34, and has a deformed parallelogram-like shape as viewed in plan (see FIG. 7). More specifically, in a state in which the respective leg sections 88, 90 are fixed to the upper frame member 56, the mounting section 86 includes a rearward region 94 positioned on a rearward side, lateral regions 96L, 96R that extend in forward and rearward directions on left and right sides, and a forward region 98 positioned on a forward side.

A rear end region (first region) 100, which extends in a widthwise direction of the seat from the rear end of one of the lateral regions 96R, and a rearwardly inclined region (second region) 102, which extends in a forwardly slanted direction from the rear end region 100 and is contiguous to the rear end of the other of the lateral regions 96L, are disposed on the rearward region 94. A forwardly inclined region 104, which extends in a forwardly slanted direction from the front end of one of the lateral regions 96R, and a front end region 106, which extends in a widthwise direction of the seat from the forwardly inclined region 104 and is contiguous to the other of the lateral regions 96L, are disposed on the forward region 98.

Further, the mounting section 86 includes a mount 108 on which the seatbelt guide 34 is mounted, and a peripheral wall 110 that projects outwardly from edges of the mount 108. More specifically, the mounting section 86 is formed with a C-shape in cross section (see FIG. 10).

A pair of positioning holes 112, 114, into which two non-illustrated positioning pins of the seatbelt guide 34 are inserted, and a fastening hole 116, through which a non-illustrated fastening member is inserted for fixing the seatbelt guide 34 to the mount 108, are formed on the mount 108.

The positioning hole (hole) 112 is positioned adjacent to and forwardly of the rear end region 100 of the mounting section 86, whereas the positioning hole 114 is positioned adjacent to and rearwardly of the front end region 106 of the mounting section 86. The fastening hole 116 is positioned between the positioning hole 112 and the positioning hole 114.

The leg section 88 extends from a portion that makes up the lateral region 96L within the peripheral wall 110, and the leg section 90 extends from a portion that makes up the lateral region 96R within the peripheral wall 110. The respective leg sections 88, 90 are fixed to the upper frame member 56, for example, by welding.

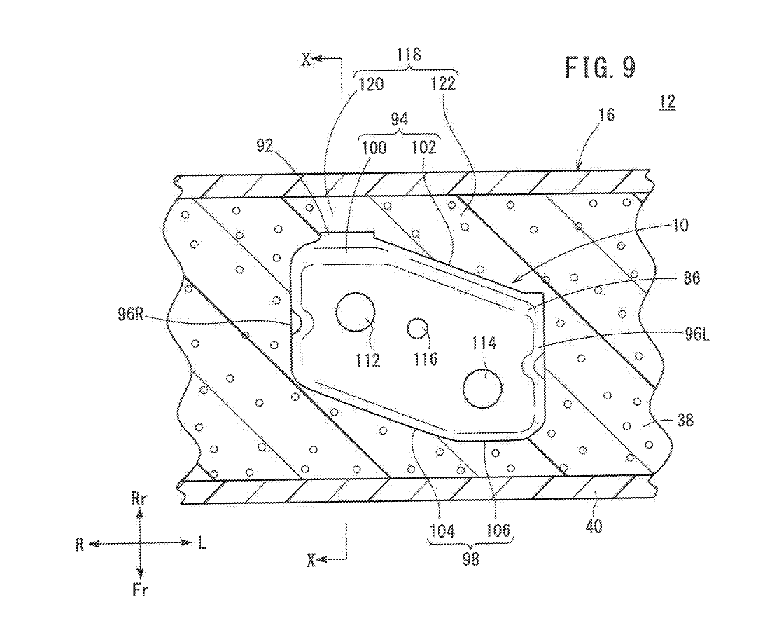

The entry prevention section 92 extends from a portion that makes up the rearward region 94 within the peripheral wall 110 (downwardly) toward a side at which the respective leg sections 88, 90 are positioned. Consequently, within the back pad 38, a pad rear portion 118, which is positioned more rearwardly than the support tool 10, can suitably be suppressed or prevented from penetrating into the gap S (see FIGS. 8 through 10).

Further, in the present embodiment, the entry prevention section 92 is disposed over the entire length of the rear end region 100 of the mounting section 86. Consequently, within the pad rear portion 118, a region (thin-walled region 120), which is positioned rearwardly of the rear end region 100 that constitutes the mounting section 86, can suitably be suppressed from penetrating into the gap S.

However, in the present embodiment, the entry prevention section 92 is disposed up to the rearwardly inclined region 102 of the mounting section 86. In this case, within the pad rear portion 118, a region (thick-walled region) 122, which is positioned behind the rearwardly inclined region 102 that constitutes the mounting section 86, can also suitably be suppressed from penetrating into the gap S.

As understood from FIG. 10, the entry prevention section 92 is disposed above the panel member 42, in a state in which the respective leg sections 88, 90 are fixed to the upper frame member 56. Further, the entry prevention section 92 is kept out of contact with the panel member 42, in a state of substantial agreement between the position thereof in the forward and rearward direction and the position of the panel member 42. Consequently, abnormal noises produced by contact (i.e., hitting against one another) between the entry prevention section 92 and the back frame 36 can suitably be suppressed.

Furthermore, a distal end part of the entry prevention section 92 may be bent (forwardly) toward an inner side of the mounting section 86. Consequently, since it can be made more difficult for the pad rear portion 118 to come into contact or impinge against the distal end (edge) of the entry prevention section 92, damage to the pad rear portion 118 can suitably be suppressed.

Incidentally, in the case that the leg sections 88, 90 are included, which extend from the mounting section 86 of the support tool 10 and are capable of being fixed to the upper frame member 56 of the seat frame section 45, the gap S is formed between the mounting section 86 and the seat frame section 45 (panel member 42).

With the gap being formed in this manner, when the trim cords 84 are engaged (latched) onto the engaging members 48a to 48l of the panel member 42, in a state in which the skin material 40 that covers the back pad 38 is placed under tension, there is a concern that a portion of the pad rear portion 118 may become pressed into (penetrate or sink into) the gap S.

However, according to the present invention, the entry prevention section 92, which prevents the pad rear portion 118 from entering into the gap S between the panel member 42 and the mounting section 86, is provided on the mounting section 86. Therefore, when the trim cords 84 are engaged with the engaging members 48a to 48l of the panel member 42, in a state in which the skin material 40 that covers the back pad 38 is placed under tension, penetration of the portion of the pad rear portion 118 into the gap S can be suppressed. As a result, since deformation and damage to the pad rear portion 118 is suppressed, the feeling one experiences when seated on the seat device 12 can suitably be maintained.

According to the present invention, since the entry prevention section 92 is formed integrally with the mounting section 86, the rigidity of the entry prevention section 92 can be increased.

Further, in a state in which the respective leg sections 88, 90 are fixed to the upper frame member 56, the entry prevention section 92 is formed to extend from the rearward region 94 of the mounting section 86 toward a side where the leg sections 88, 90 are positioned. Thus, the pad rear portion 118 of the back pad 38 can be suppressed from penetrating into the gap S. Furthermore, since the entry prevention section 92 extends out from the rear end region 100 of the mounting section 86, the pad rear portion 118 can more effectively be suppressed from penetrating into the gap S.

According to the present embodiment, in a state in which the respective leg sections 88, 90 are fixed to the upper frame member 56, the rearward region 94 of the mounting section 86 includes the rear end region 100 that extends along the widthwise direction of the seat, and the rearwardly inclined region 102 that extends in a forwardly slanted direction from the rear end region 100. Therefore, the thickness of the region (thin-walled region) 120, which is positioned rearwardly of the rear end region 100 within the pad rear portion 118, is thinner than the thickness of the region (thick-walled region) 122, which is positioned rearwardly of the rearwardly inclined region 102.

In addition, the thin-walled region 120 of the pad rear portion 118 penetrates more easily into the gap S than the thick-walled region 122. However, since the entry prevention section 92 is provided on the rear end region 100, entry or penetration of the thin-walled region 120 into the gap S can suitably be suppressed.

Further, in the present embodiment, the entry prevention section 92 is disposed adjacent to (in the vicinity of) the positioning hole 112 in the mounting section 86. Stated otherwise, the entry prevention section 92 is disposed rearwardly of the positioning hole 112 in the mounting section 86. Thus, even if the positioning hole 112 is formed in this manner in the mounting section 86, a decrease in the rigidity of the mounting section 86 can be suppressed. Consequently, the seatbelt guide 34 can be attached stably to the mounting section 86.

According to the present embodiment, when the back frame 36 is manufactured, the reinforcing members 68L, 68R are joined with respect to intermediate portions in the heightwise direction of the bridge frame members 62L, 62R. The ends of the reinforcing members 68L, 68R are arcuately shaped with semicircular shapes in cross section to match with the curvature of the bridge frame members 62L, 62R (see FIG. 5), and therefore, the ends can be joined easily with respect to the bridge frame members 62L, 62R. Further, since regions apart from the ends thereof are formed with a gate-like shape (C-shape) in cross section (see FIG. 4), the reinforcing members 68L, 68R also are manufactured easily.

Furthermore, the windows 70a, 70b are provided in the reinforcing members 68L, 68R, and are joined with respect to the bridge frame members 62L, 62R that are exposed from the windows 70a, 70b, and therefore, the bonding strength between the reinforcing members 68L, 68R and the bridge frame members 62L, 62R is increased. As a result, the rigidity of the bridge frame members 62L, 62R is further enhanced. In addition, the mounting rigidity of the reinforcing members 68L, 68R to the bridge frame members 62L, 62R also is improved.

The back pad 38 and the skin material 40 that covers the back pad 38 are mounted with respect to the seat back frame 36, thereby forming the seat device (rear seat) 12. Of course, at this time, the trim cords 84 provided on the skin material 40 are engaged with the engaging members 48a to 48l.

In this case, the engaging members 48a, 48b are disposed parallel to the reinforcing member 68L across the entirety thereof, and the engaging members 48c, 48d are disposed parallel to the reinforcing member 68R across the entirety thereof. Therefore, due to the presence of the reinforcing members 68L, 68R, the engaging members 48a to 48d exhibit sufficient rigidity. Consequently, even if a large tensile force acts on the engaging members 48a to 48d through the trim cords 84, deformation of the engaging members 48a to 48d is avoided.

The seat device 12, which is obtained in the foregoing manner, is mounted in an automobile body. At this time, the seat back 16 faces both the vehicle compartment and the trunk room.

In the event that luggage is stored in the trunk room without being fixed in place, for example, when the vehicle travels up a meandering slope or when the vehicle is subjected to sudden braking, there is a possibility for the luggage to slide and come into abutment against, i.e., impact, the seat back 16.

In the present embodiment, as has been described above, the reinforcing members 68L, 68R are disposed with respect to the bridge frame members 62L, 62R for enhancing the rigidity around the periphery of the through hole 46, which serves as a trunk-through portion (opening 23). Therefore, the rigidity of the bridge frame members 62L, 62R, or the rigidity of the area around the through hole 46 of the panel member 42, is large. In addition, since the beads 50 extend at multiple locations to a position below the frame body 44, the rigidity of the panel member 42 itself is large. Accordingly, even supposing that heavy luggage comes into abutment against the bridge frame members 62L, 62R or the periphery of the through hole 46, deformation of the frame body 44 or the panel member 42 is avoided.

In conclusion, according to the present embodiment, even with a through hole 46 such as a trunk-through portion or the like being disposed in the seat back 16, the rigidity of the frame body 44 or the panel member 42 can be ensured.

Therefore, even when heavy luggage comes into abutment against the seat back 16, deformation of the frame body 44 (in particular, the bridge frame members 62L, 62R) or the panel member 42 can be suppressed. In addition, there is no need for the size or the wall-thickness of the bridge frame members 62L, 62R to be increased.

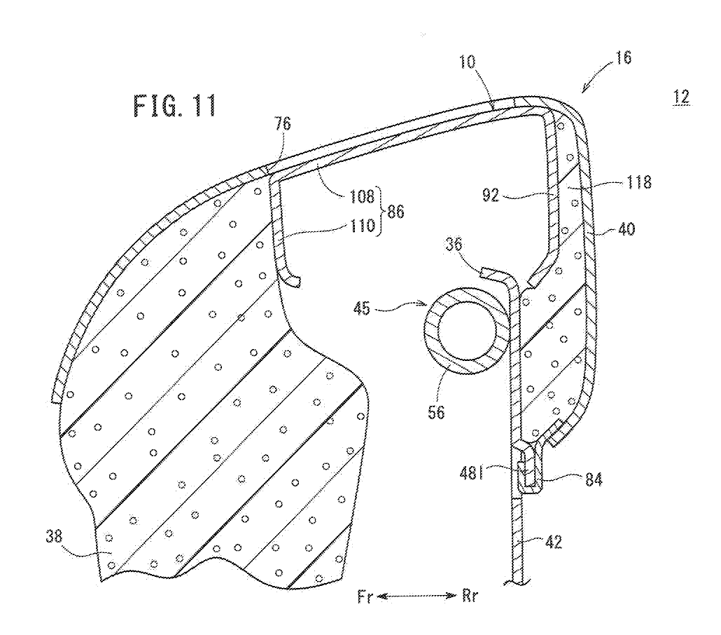

The present invention is not limited to the embodiment described above. For example, as shown in FIG. 11, in a state in which the respective leg sections 88, 90 are fixed to the upper frame member 56, the entry prevention section 92 may be formed to extend rearwardly of the panel member 42 in overlapping relation to the panel member 42 when viewed from the front. In this case, the pad rear portion 118 can more effectively be suppressed from penetrating into the gap S.

Further, in the support tool 10 according to the present embodiment, either one of the pair of leg sections 88, 90 may be dispensed with.

Further, for example, although the frame body 44 is constituted respectively by the U-shaped frame member 54, the upper frame member 56, and the bridge frame members 62L, 62R, the frame body 44 may be constructed as a unitary member having an overall frame portion defined integrally thereby.

Further, although the reinforcing members 68L, 68R are disposed in parallel across the entirety of the engaging members 48a to 48d, even in a situation in which only portions of each of the engaging members 48a to 48d are disposed in parallel with the reinforcing members 68L, 68R, the engaging members 48a to 48d are capable of exhibiting sufficient rigidity.

Furthermore, the reinforcing members 68L, 68R may serve to cover other locations except for the hook portions of the bridge frame members 62L, 62R. Alternatively, the reinforcing members may be provided as a two-piece structure covering only locations in the vicinity of the hook portions, or as a three-piece structure that covers regions in the vicinity of the hook portions as well as intermediate portions of the bridge frame members 62L, 62R.

Further still, it is permissible for the through hole 46 not to be made in the form of a trunk-through portion. In addition, the seat back frame 36 according to the present invention is not strictly limited to the seat device 12, which is constituted as a rear seat. The seat back frame 36 may be constituted as a front seat, or as a middle seat for a station wagon type of vehicle.

In addition, only one of the bridge frame members 62L and 62R may be provided alone.

The present invention is not limited to the embodiments described above, and various modified or alternative configurations may be adopted therein, without departing from the essence of the present invention.

1. A seatbelt guide support tool that supports a seatbelt guide, and is disposed on a seat frame section that supports a pad member that makes up part of a seat device, comprising:
a mounting section to which the seatbelt guide is attached;
a leg section disposed on the mounting section and which is capable of being fixed to the seat frame section; and
an entry prevention section disposed on the mounting section, and which prevents the pad member from entering into a gap provided between the mounting section and the seat frame section.

2. The seatbelt guide support tool according to claim 1, wherein the entry prevention section is formed integrally with the mounting section.

3. The seatbelt guide support tool according to claim 2, wherein, in a state in which the leg section is fixed to the seat frame section, the entry prevention section extends from a rearward region positioned on a rearward side of the seat within the mounting section toward a side at which the leg section is positioned.

4. The seatbelt guide support tool according to claim 3, wherein the entry prevention section extends from a rear end of the mounting section.

5. The seatbelt guide support tool according to claim 4, wherein, in a state in which the leg section is fixed to the seat frame section, the rearward region includes:
a first region that extends in a widthwise direction of the seat; and
a second region that extends in a forwardly slanted direction from the first region,
wherein the entry prevention section extends from the first region.

6. The seatbelt guide support tool according to claim 1, wherein a distal end part of the entry prevention section is bent toward an inner side of the mounting section.

7. The seatbelt guide support tool according to claim 1, wherein:
a hole for attachment of the seatbelt guide is formed in the mounting section; and
the entry prevention section is disposed adjacent to the hole in the mounting section.

8. The seatbelt guide support tool according to claim 1, wherein, in a state in which the leg section is fixed to the seat frame section, the entry prevention section is formed to remain out of contact with the seat frame section.

9. The seatbelt guide support tool according to claim 8, wherein, in a state in which the leg section is fixed to the seat frame section, the entry prevention section is formed to extend rearwardly of the seat frame section in overlapping relation to the seat frame section when viewed from front.

10. A seat back frame equipped with a seat frame section having a panel member and a frame body joined to the panel member and which supports a pad member that makes up part of a seat device, and a seatbelt guide support tool that supports a seatbelt guide and is disposed on the seat frame section,
the seatbelt guide support tool comprising:
a mounting section to which the seatbelt guide is attached;
a leg section disposed on the mounting section and which is capable of being fixed to the seat frame section; and
an entry prevention section disposed on the mounting section, and which prevents the pad member from entering into a gap provided between the mounting section and the seat frame section;
wherein a through hole is formed in the panel member;
the frame body comprising:
an edge frame disposed around an edge of the panel member; and
a bridge frame that is bridged over the edge frame and is disposed around the through hole;
wherein at least a portion of the bridge frame is covered by a reinforcing member.

11. The seat back frame according to claim 10, wherein:
the through hole extends from a lower part on a seat surface side to an upper part on a side at which a headrest is attached; and
the reinforcing member is arranged at least at an intermediate portion in a heightwise direction of the bridge frame.

12. The seat back frame according to claim 10, wherein:
an engaging member for engagement with a trim cord is disposed around the through hole;
the reinforcing member extends in parallel with respect to the engaging member; and
at least a portion of the reinforcing member and a portion of the engaging member face one another mutually in parallel.

13. The seat back frame according to claim 10, wherein:
a plurality of engaging members for engagement with trim cords are disposed around the through hole;
the reinforcing member extends in parallel with respect to the plurality of engaging members; and
at least a portion of the reinforcing member and portions of the plurality of engaging members face one another mutually in parallel.

14. The seat back frame according to claim 10, wherein a window is formed in the reinforcing member, and the reinforcing member and a region of the bridge frame that is exposed from the window are joined to each other by welding.

15. The seat back frame according to claim 14, wherein:
the frame body includes, as the bridge frame, two members arranged on opposite ends of the through hole;
the reinforcing members are disposed respectively on each of the two bridge frames;
the windows are formed respectively on opposite ends of the reinforcing members; and
the reinforcing members and the regions of the bridge frames that are exposed from the windows are joined to each other by welding.

16. The seat back frame according to claim 10, wherein the bridge frame is circular in cross section, an end of the reinforcing member is arcuately shaped in cross section and welded to the bridge frame, and a region other than the end of the reinforcing member is gate-shaped in cross section.

17. The seat back frame according to claim 10, wherein:
a bead is disposed on the panel member; and
the bead extends to a lower side of a vehicle body mounting portion provided on a lower end of the panel member.

18. The seat back frame according to claim 10, wherein the seat back frame is for a rear seat, and the through hole serves to provide a state of communication between a vehicle compartment and a trunk room.

19. A seat device comprising:
a pad member;
a seat frame section that supports the pad member;
a skin material covering the pad member; and
a seatbelt guide support tool that supports a seatbelt guide and is disposed on the seat frame section,
the seatbelt guide support tool comprising:
a mounting section to which the seatbelt guide is attached;
a leg section disposed on the mounting section and which is capable of being fixed to the seat frame section; and
an entry prevention section disposed on the mounting section, and which prevents the pad member from entering into a gap provided between the mounting section and the seat frame section.
